(19) United States
(12) Patent Application Publication
(10) Pub. No.: US 2011/0229072 A1
(43) Pub. Date: Sep. 22, 2011

(54) OPTICAL WAVEGUIDE DEVICE AND OPTICAL RECEIVER EQUIPPED WITH SAME

(75) Inventor: Seok-Hwan JEONG, Kawasaki (JP)

(73) Assignee: FUJITSU LIMITED, Kawasaki-shi (JP)

(21) Appl. No.: 13/040,414

(22) Filed: Mar. 4, 2011

(30) Foreign Application Priority Data
Mar. 17, 2010 (JP) 2010-60788

(51) Int. Cl. G02B 6/12; G02B 6/26

(52) U.S. Cl. 385/14; 385/28

(57) ABSTRACT

An optical waveguide device includes a plurality of input channels, a plurality of output channels, and a multi-mode interference coupler having one end part coupled to the plurality of input channels and another end part coupled to the plurality of output channels, the multi-mode interference coupler includes a first part gradually narrowing in width from the one end part to the other end part, a second part coupling to the first part and extending from the one end part to the other end part while keeping the width of a coupling part between the first part and the second part, and a third part coupling to the second part and gradually thickening in width from the one end part to the other end part.

### CROSS-REFERENCE TO RELATED APPLICATIONS

This application is based upon and claims the benefit of priority from the prior Japanese Patent Application No. 2010-60788 filed on Mar. 17, 2010, the entire contents of which are incorporated herein by reference.

### FIELD

The present invention relates to an optical waveguide device and an optical receiver equipped with such an optical waveguide device.

### BACKGROUND

In recent years, an increase in bit rate has been desired to increase the capacity of transmission in an optical transmission system. In order to improve transmission capacity, for example, a multiple-value phase deviation may be used without an increase in bit rate.

Specifically, examples of the multiple-value phase deviation include a quadrature phase shift keying (QPSK) or a differential quadrature phase shift keying (DQPSK).

In order to demodulate a QPSK or DQPSK signal beam, for example, a coherent optical receiver with an optical hybrid circuit has been used. The optical hybrid circuit is a principle circuit in the coherent optical receiver. The optical hybrid circuit is designed to output four signal beams according to the phase modification state of the input QPSK or DQPSK signal beam and then take out multi-valued information.

For manufacturing a coherent optical receiver excellent in cost performance, an optical hybrid circuit has been desired to be reduced in size.

FIG. 1 is a diagram illustrating a first example of the related-art optical hybrid circuit.

An optical hybrid circuit 111 shown in FIG. 1 is constructed of four 3-dB couplers and a 90-degree phase shifter. The 3-dB couplers are coupled to one another via optical waveguides, respectively. In addition, the 90-degree phase shifter is coupled to the 3-dB couplers via optical waveguides, respectively. The optical hybrid circuit 111 receives both a QPSK signal beam and a local oscillation beam (LO beam) through two input channels, respectively. Then, four output beams with different phases each shifted by 90 degrees can be output from the respective output channels. The output beams include S−L and S+L signal beams, which are in-phase components, and S−jL and S+jL signal beams, which are orthogonal components.

However, the optical hybrid circuit 111 shown in FIG. 1 includes many elements for constructing the circuit, limiting the miniaturization of the optical hybrid circuit.

FIG. 2 is a diagram illustrating a second example of the related-art optical hybrid circuit.

The optical hybrid circuit 112 shown in FIG. 2 includes four input channels, four output channels, and a rectangular 4:4 multi-mode interference (MMI) coupler. The optical hybrid circuit 112 receives a QPSK signal beam and a LO beam as inputs through two input channels among four input channels, which are asymmetrical with respect to the center axis of the coupler in the optical propagation direction. Subsequently, the input signal beam is self-imaged by multi-mode interference in the MMI coupler and four output beams with different phases each shifted by 90 degrees are then output from the respective output channels.

Comparing with the optical hybrid circuit shown in FIG. 1, the optical hybrid circuit 112 has a simple structure and the size thereof in the optical propagation direction (hereinafter, simply referred to as a device length) can be shortened. The rectangular optical hybrid circuit shown in FIG. 2 has a given device length L_{MMI} proportional to the square of the width of the optical hybrid circuit W_{MMI} (i.e., the size in the direction perpendicular to the optical propagation direction). Then, the rectangular optical hybrid circuit shown in FIG. 2 needs to reduce its width W_{MMI} to shorten the device length L_{MMI}.

However, to reduce the width W_{MMI} while keeping the width of the input channel as it is, the distance (gap) between the adjacent input channels should be shortened to reduce the width W_{MMI} while keeping the width of the input channel. However, a reduction in distance (gap) is limited from a standpoint of processing accuracy in manufacturing steps, such as etching. Therefore, there is a limit in shortening the device length L_{MMI} of the rectangular optical hybrid circuit.

FIG. 3 is a diagram illustrating a third example of the related-art optical hybrid circuit.

An optical hybrid circuit 113 shown in FIG. 3 includes a MMI coupler where both end parts thereof form a butterfly tapered shape. The width of the MMI coupler gradually decreases in taper in the optical propagation direction and then gradually increases in taper. The width of the input side of the MMI coupler is W_{MMI} which is equal to that of the optical hybrid circuit 112 shown in FIG. 2. However, the width of the middle of the MMI coupler in the optical propagation direction is W_{MB} which is narrower than the width W_{MMI} of the input side. Both end parts of the MMI coupler have discontinuous points on the regions corresponding to the width W_{MB} of the middle part. The optical hybrid circuit 113 having such a configuration is designed to reduce the device length by decreasing the average width.

FIG. 4 is a diagram illustrating a fourth example of the related-art optical hybrid circuit.

In an optical hybrid circuit 114 shown in FIG. 4, both side parts of a MMI coupler are in the form of an inwardly parabolic arch shape. The width of the MMI coupler continuously decreases and then continuously increases in the optical propagation direction. The width of the input side of the MMI coupler is W_{MMI} which is equal to that of the optical hybrid circuit 112 shown in FIG. 2. However, the width of the middle part of the MMI coupler in the optical propagation is W_{MP} which is narrower than the width W_{MMI} of the input side thereof. The both side parts of the MMI coupler are continuous also at the middle part of the width W_{MP}. The optical hybrid circuit 114 having such a configuration is also designed to reduce the device length by decreasing the average width.

### SUMMARY

According to aspects of embodiments, an optical waveguide device includes a plurality of input channels, a plurality of output channels, and a multi-mode interference coupler having one end part coupled to the plurality of input channels and another end part coupled to the plurality of output channels, the multi-mode interference coupler includes a first part gradually narrowing in width from the one end part to the other end part, a second part coupling to the first part and extending from the one end part to the other end part while keeping the width of a coupling part between the first part and the second part, and a third part coupling to the second part and gradually thickening in width from the one end part to the other end part.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of the related-art optical hybrid circuit;

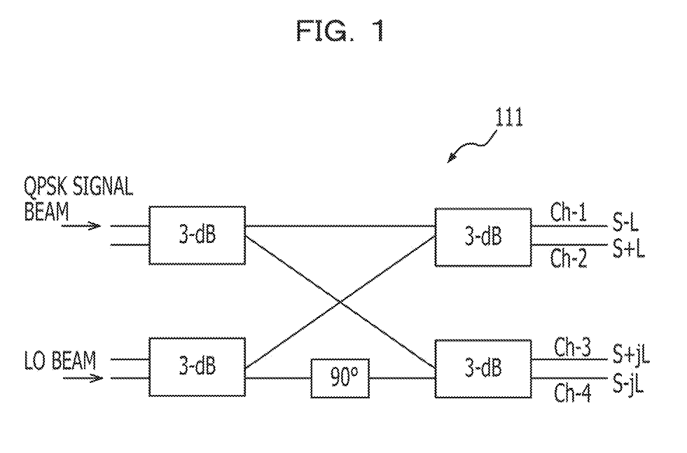

FIG. 2 is a diagram illustrating a second example of the related-art optical hybrid circuit;

FIG. 3 is a diagram illustrating a third example of the related-art optical hybrid circuit;

FIG. 4 is a diagram illustrating a fourth example of the related-art optical hybrid circuit;

FIG. 5 is a diagram illustrating an optical hybrid circuit according to a first embodiment disclosed in the present specification;

FIG. 6 is a diagram illustrating a wavefront propagating through the optical hybrid circuit shown in FIG. 5;

FIGS. 7A to 7E are diagrams each illustrating the relationship between the transmittance of each output channel and the wavelength of an input signal beam when the length of the second part of the multi-mode interference coupler of the optical hybrid circuit is changed;

FIGS. 8A to 8E are diagrams each illustrating the relationship between the phase shift of each output channel and the wavelength of an input signal beam when the length of the second part of the multi-mode interference coupler of the optical hybrid circuit is changed;

FIG. 9 is a diagram illustrating the wavefront propagating the inside of the optical hybrid circuit shown in FIG. 3;

FIG. 10A is a diagram illustrating the relationship between the transmittance of each output channel of the optical hybrid circuit shown in FIG. 4 and the wavelength of an input signal beam, and FIG. 10B is a diagram illustrating the relationship between the phase shift of each output channel and the wavelength of an input signal beam;

FIG. 11 is a diagram illustrating a wavefront propagating in the optical hybrid circuit shown in FIG. 4;

FIG. 12 is a diagram making a comparison between the shortening rate of the optical hybrid circuit of the first embodiment and the shortening rate of the optical hybrid circuit shown in each of FIG. 3 and FIG. 4;

FIG. 13 is a diagram illustrating the relationship between the length of the second part and the shortening rate of the optical hybrid circuit according to the first embodiment;

FIG. 14 is a diagram illustrating the relationship between the phase shift of each output channel and the wavelength of an input signal beam when the shortening rate of the optical hybrid circuit of the first embodiment is set to 0.58;

FIG. 15 is a diagram illustrating the relationship between the phase shift of each output channel and the wavelength of an input signal beam when the shortening rate of the optical hybrid circuit shown in FIG. 4 is set to 0.58;

FIG. 16 is a cross-sectional diagram along the line X-X of FIG. 5;

FIG. 17 is a diagram illustrating an optical hybrid circuit according to a second embodiment disclosed in the present specification;

FIG. 18A is a diagram illustrating the relationship between the transmittance of each output channel of the optical hybrid circuit of the first embodiment and the wavelength of an input signal beam, and FIG. 18B is a diagram illustrating the relationship between the transmittance of each output channel of the optical hybrid circuit of the second embodiment and the wavelength of an input signal beam;

FIG. 19A is a diagram illustrating the relationship between the phase shift of each output channel of the optical hybrid circuit of the first embodiment and the wavelength of an input signal beam, and FIG. 19B is a diagram illustrating the relationship between the phase shift of each output channel of the optical hybrid circuit of the second embodiment and the wavelength of an input signal beam;

FIG. 20 is a diagram illustrating an optical hybrid circuit according to a third embodiment disclosed in the present specification;

FIG. 21A is a diagram illustrating the relationship between the transmittance of each output channel of the optical hybrid circuit of the first embodiment and the wavelength of an input signal beam, and FIG. 21B is a diagram illustrating the relationship between the transmittance of each output channel of the optical hybrid circuit of the third embodiment and the wavelength of an input signal beam;

FIG. 22A is a diagram illustrating the relationship between the phase shift of each output channel of the optical hybrid circuit of the first embodiment and the wavelength of an input signal beam, and FIG. 22B is a diagram illustrating the relationship between the phase shift of each output channel of the optical hybrid circuit of the third embodiment and the wavelength of an input signal beam;

FIG. 23 is a diagram illustrating an optical receiver according to one embodiment disclosed in the present specification;

FIG. 24 is a diagram illustrating the transmittance of each output channel when a QPSK signal is input into the optical receiver shown in FIG. 23; and

FIG. 25 is a diagram illustrating an optical hybrid circuit according to another embodiment disclosed in the present specification.

### DESCRIPTION OF EMBODIMENTS

Preferred embodiments will be explained with reference to accompanying drawings.

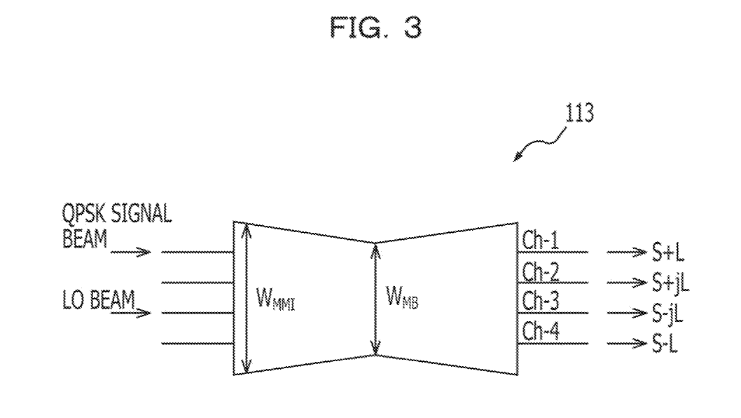

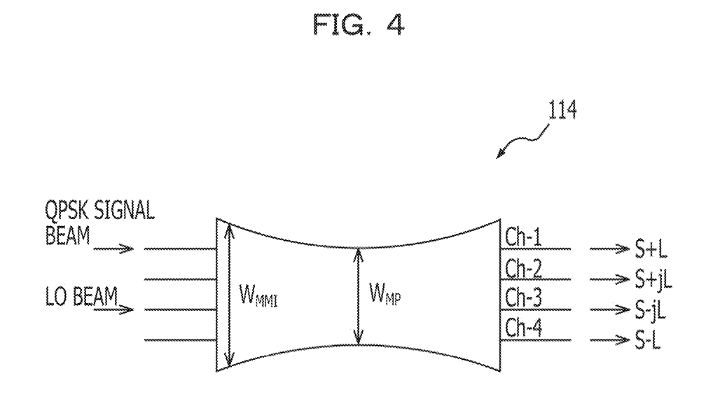

Each of the optical hybrid circuits shown in FIG. 3 and FIG. 4 is provided for reducing the device size of the MMI coupler. However, further improvements have been desired for the optical hybrid circuits shown in FIG. 3 and FIG. 4 with respect to their optical properties, such as outputs of input beams after equal distribution or retention of phase information in a multilevel phase-shift keying signal where the phase information of each output signal has been input.

The optical hybrid circuit as an optical waveguide device disclosed in the present specification is suitably used for inputting a multilevel phase-shift keying signal beam, changing the phase of the input signal to demodulate a multileveled signal. The optical hybrid circuit disclosed in the present specification can be used for demodulating a multilevel phase-shift keying signal beam, such as BPSK, QPSK, or 8PSK, or a multilevel amplitude-phase-shift keying signal beam, such as 16QAM or 64QAM. In the following description, an exemplary optical hybrid circuit will be described for demodulation of QPSK signal beam. The number of input channels and the number of output channels of the optical hybrid circuit can be appropriately defined according to signal beams to be input.

Hereinafter, an optical hybrid circuit as an example of the optical waveguide device according to a first embodiment disclosed in the present specification will be described with reference to the attached drawing. However, it is noted that the technical scope of the embodiments is not limited to that of those disclosed herein but interpreted within that of the claimed invention and equivalents thereof.

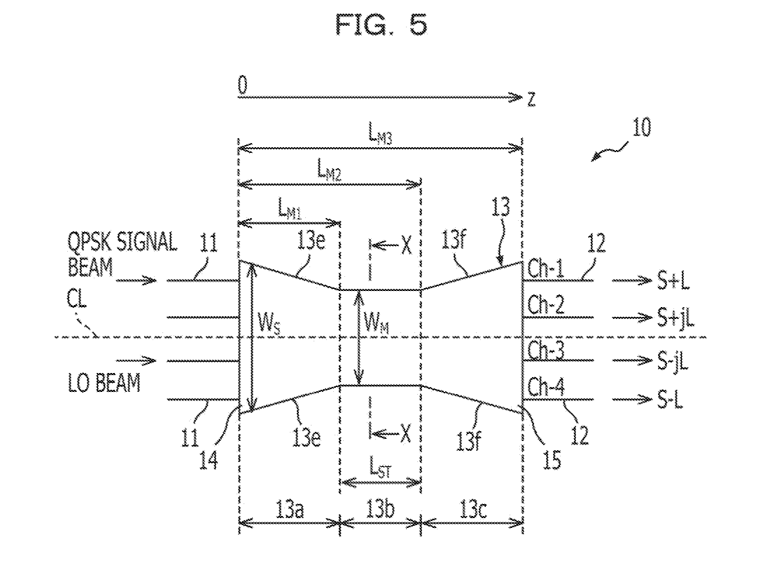

FIG. 5 is a diagram illustrating the optical hybrid circuit according to a first embodiment disclosed in the present specification.

An optical hybrid circuit 10 of the present embodiment includes four input channels 11, four output channels 12, and a multi-mode interference coupler 13 where one end part 14 thereof is coupled to four input channels 11 and another end part 15 thereof is coupled to four output channels 12. The multi-mode interference coupler 13 allows a light beam to propagate from one end part 14 to the other end part 15.

The multi-mode interference coupler 13 includes a first part 13a gradually narrowing in width from one end part 14 to the other end part 15, a second part 13b coupling to the first part 13b and extending from one end part 14 to the other end part 15 while keeping the width of the coupling part, and a third part 13c coupling to the second part 13b and gradually thickening in width from one end part 14 to the other end part 15. The width of the coupling between the first part 13a and the second part 13b is substantially equal to the width of the coupling between the second part 13b and the third part 13c. In the present specification, the direction extending from one end part 14 to the other end part 15 of the multi-mode interference coupler 13 is also referred to as an optical propagation direction.

The width of the first part 13a of the multi-mode interference coupler 13 is defined by a pair of side parts 13e which are opposite to each other and symmetrical with respect to a center axis CL in the width direction. The profiles of the respective side parts 13e are linear. Here, the width of the first part 13a means a length in the direction perpendicular to the optical propagation direction of the first part 13a. This is also applied to the width of each of the second part 13b and the third part 13c.

One end part 14, which serves as a free end of the first part 13a, has a given width W_{S} and four input channels 11 are coupled to the end part 14. These four input channels 11 are arranged at regular intervals and symmetrical with respect to the center axis CL in the width direction of the optical hybrid circuit 10. The length of the first part 13a is represented as L_{M1}.

The width of the third part 13c of the multi-mode interference coupler 13 is defined by a pair of side parts 13f which are opposite to each other and symmetrical with respect to the center axis CL in the width direction. The profile of each side part 13f is also linear.

The other end part 15, which serves as a free end of the third part 13c, has a given width W_{S} and four input channels 12 are coupled to the end part 15. These four output channels 12 are arranged at regular intervals and symmetrical with respect to the center axis CL in the width direction of the optical hybrid circuit 10. In FIG. 5, four channels are numbered Ch-1, Ch-2, Ch-3, and Ch-4, respectively.

The second part 13b sandwiched between the first part 13a and the third part 13c is in a rectangular shape. The width of the second part 13b is W_{M} and the length of the second part 13b in the optical propagation direction is L_{ST}.

The width of the first part 13a is gradually decreased from W_{S} to W_{M} in the optical propagation direction to form a taper shape. The width of the third part 13c is gradually increased from W_{M} to W_{S} to form a reverse taper shape.

In the optical hybrid circuit 10, both the first part 13a and the third part 13c have substantially the same length in the optical propagation direction.

The optical hybrid circuit 10 is designed to form the first part 13a and the third part 13c are symmetrical with respect to the center axis (not shown) in the optical propagation direction of the optical hybrid circuit 10. Therefore, both four input channels 11 and four output channels 12 are also formed symmetrical with respect to the central axis (not shown) in the optical propagation direction.

In FIG. 5, the direction extending from one end part 14 to the other end part 15 of the multi-mode interference coupler 13 is represented as a positive direction along the z axis.

In the optical hybrid circuit 10 shown in FIG. 5, the sum of the lengths of the first and second parts 13a and 13b in the z axis direction is represented as a given length L_{M2}. In addition, the length of the multi-mode interference coupler 13 in the z axis direction is represented as L_{M3}.

A QPSK signal beam and a LO beam are input into the optical hybrid circuit 10 through two input channels among four input channels 11. These two input channels are asymmetrical with respect to the central axis CL in the width direction. For example, other two remaining input channels which are not used do not need to be formed. In this case, the optical hybrid circuit 10 includes two input channels 11 and four output channels 12.

Therefore, the optical hybrid circuit 10 receives a QPSK signal beam and a LO beam as inputs through two input channels which are asymmetrical to the center axis of the coupler in the optical propagation direction. The QPSK signal beam and the LO beam entered from the input channels 11 are self-imaged by multi-mode interference based on general interference in the multi-mode interference coupler 13 and four different signal beams are then output from the respective output channels 12.

Preferably, the optical hybrid circuit 10 may have optical performance that allows an input beam from any of the input channels to be equally divided into different beams and then output from the respective output channels. Preferably, furthermore, the optical hybrid circuit 10 may have optical performance that results in a small phase shift in between the phase of each signal beam output from the output channel and the phase of the input QPSK signal beam.

The optical hybrid circuit 10 adjusts the length L_{ST} of the second part in the optical propagation to a certain length to shorten the length of the multi-mode interference coupler 13 in the optical propagation direction (hereinafter, simply referred to as a device length), while providing excellent optical performance.

Specifically, the length L_{ST} of the second part 13b of the multi-mode interference coupler 13 in the optical propagation direction is preferably determined as follows: The length L_{ST} is defined so that a QPSK signal beam is input into any of four input channels 11 and the difference among the respective signal beams output from four output channels 12 is set to 3 dB or less based on the optical strength of the input QPSK signal beam. More preferably, the length L_{ST} is defined so that the difference among the respective signal beams output from four output channels 12 is set to 2 dB or less based on the optical strength of the input QPSK signal beam. Still more preferably, the length L_{ST} is defined so that the difference among the respective signal beams output from four output channels 12 is set to 1 dB or less based on the optical strength of the input QPSK signal beam.

Preferably, furthermore, the length L_{ST} of the second part 13b of the multi-mode interference coupler 13 may be determined as follows: The length L_{ST} is defined so that the phase shift among the output signal beams from four output channels is set to within the range of −10 to +10 degrees. Specifically, if the output signal beam is an in-phase component, the length L_{ST} may be preferably defined so that the phase of the signal beam is within the range of −10 to +10 degrees with respect to 0 or 180 degrees. In addition, if the output signal beam is an orthogonal component, the length L_{ST} may be preferably defined so that the phase of the signal beam is within the range of −10 to +10 degrees with respect to 90 or 270 degrees. More preferably, the length L_{ST} is defined so that a shift difference among the respective signal beams output from four output channels is set to within the range of −5 degrees to +5 degrees. Specifically, if the output signal beam is an in-phase component, the length L_{ST} may be preferably defined so that the phase of the signal beam is within the range of −5 to +5 degrees with respect to 0 or 180 degrees. In addition, if the output signal beam is an orthogonal component, the length L_{ST} may be preferably defined so that the phase of the signal beam is within the range of −5 to +5 degrees with respect to 90 or 270 degrees.

Next, the device length of the multi-mode interference coupler 13 of the optical hybrid circuit 10 will be described below.

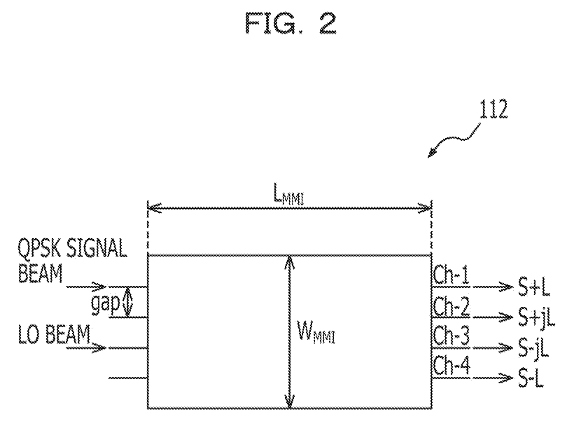

First, the relationship between the preferred device length L_{MMI} of the rectangular multi-mode interference coupler shown in FIG. 2 and the width W_{MMI} of the multi-mode interference coupler will be described. Next, using the device length L_{MMI} of such a rectangular multi-mode interference coupler, the device length of the multi-mode interference coupler 13 of the optical hybrid circuit 10 will be represented.

The preferred device length L_{MMI} of the rectangular multi-mode interference coupler shown in FIG. 2 is determined depending on the width W_{MMI} of the multi-mode interference coupler, the refractive index of the waveguide, an excitation mode number, an interference mechanism, and so on. The relationship between the preferred device length L_{MMI} of the multi-mode interference coupler and the width W_{MMI} of the multi-mode interference coupler can be obtained as follows: First, in the case of the multi-mode interference coupler shown in FIG. 2, a propagation constant βv (v: propagation mode order) of any mode where a light beam propagates through the multi-mode interference coupler can be simplistically represented by equation (1):

$${β}_{v} = {k}_{0} {N}_{eq} - \frac{{( v + 1 )}^{2} π λ}{4 \cdot {N}_{eq} \cdot {W}_{MMI}^{2}} \qquad ( 1 )$$

Here, k₀, represents the wave number of a signal beam in a vacuum, N_{eq} represents the refractive index of the waveguide in the multi-mode interference coupler, and λ represents the wavelength of the signal beam. In this case, the difference between the propagation constant of a basic mode and the propagation constant of any higher-order mode, which can be excited in the multi-mode interference coupler, can be represented by equation (2).

$${β}_{0} - {β}_{v} ≅ \frac{v ( v + 2 ) π λ}{4 {N}_{eq} {W}_{M}^{2}} = \frac{v ( v + 2 ) π}{3 {L}_{π} } \qquad ( 2 )$$

Here, L_{π} represents the beat length of the multi-mode interference coupler. In the case of the rectangular multi-mode interference coupler shown in FIG. 2, the beat length L_{π} is approximated by equation (3) derived from the equation (2).

$${L}_{π} = \frac{π}{{β}_{0} - {β}_{1}} ≅ \frac{4 \cdot {N}_{eq} \cdot {W}_{MMI}^{2}}{3 \cdot λ} \qquad ( 3 )$$

Therefore, the relationship between the preferred device length L_{MMI} of the rectangular multi-mode interference coupler shown in FIG. 2 and the width W_{MMI} of the multi-mode interference coupler can be obtained as represented by equation (3a).

$${L}_{MMI} = \frac{3}{4} {L}_{π} \qquad ( 3 a )$$

Next, the device length L_{MMI} of the rectangular multi-mode interference coupler is used for obtaining the relationship between the device length of the multi-mode interference coupler 13 of the optical hybrid circuit 10 and the length L_{ST} of the second part 13b thereof shown in FIG. 5 is obtained.

First, since the width of the multi-mode interference coupler shown in FIG. 5 is not constant in the z axis direction, the difference between the propagation constant of the basic mode and the propagation mode of any higher-order mode varies in the z axis direction. Then, the difference between the propagation constant of the basic mode and the propagation mode of any higher-order mode is integrated over an interval from 0 to L_{M3} in the z axis direction to represent the variation Δρ of the phase in the multi-mode interference coupler 13 as equation (4).

$$Δ ρ = {\int }_{0}^{{L}_{M 3}} ( {β}_{0} - {β}_{v} ) d z = \frac{v ( v + 2 ) π λ}{4 \cdot {N}_{eq }} {\int }_{0}^{{L}_{M 3}} \frac{d z}{{W}_{M}^{2} ( z )} \qquad ( 4 )$$

Here, W_{M} (z) represents the width of the multi-mode interference coupler 13 with the function of z.

The function W_{M} (z) can be represented by equations (5a), (5b), and (5c) for three different intervals on the x axis.

$$\begin{matrix}{W}_{M} ( z ) = {W}_{S} + ( {W}_{M} - {W}_{S} ) \frac{z}{{L}_{M 1}} \\ ( z : {0}^{-} LM 1 ) & ( 5 a ) \\ {W}_{M} ( z ) = {W}_{M} \\ ( z : LM {1}^{-} LM 2 ) & ( 5 b ) \\ {W}_{M} ( z ) = {W}_{M} + ( {W}_{S} - {W}_{M} ) \frac{( z - {L}_{M 2} )}{{L}_{M 3} - {L}_{M 2}} \\ ( z : LM {2}^{-} LM 3 ) & ( 5 c )\end{matrix}$$

Furthermore, the length L_{ST} of the second part of the multi-mode interference coupler 13 in the z axis direction can be represented by equation (6) with the length L_{M3}.

$${L}_{ST} = ( 1 - \frac{2}{2 + f} ) \cdot {L}_{M 3} \qquad ( 6 )$$

Here, parameter f is a real number of 0 or more. The equations (5a), (5b), and (5c) are substituted into the equation (4) and then integrated, followed by considering the relation of the equation (6) to obtain equation (7).

$$\begin{matrix}Δ ρ = ( {β}_{0} - {β}_{v} ) = \frac{v ( v + 2 ) π λ}{4 \cdot {N}_{eq} \cdot {W}_{S}^{2}} {χ}^{T} & ( 7 ) \\ {χ}^{T} = \frac{{W}_{S}}{{W}_{M}} \cdot ( \frac{2}{2 + f} + \frac{f}{2 + f} \cdot ( \frac{{W}_{S}}{{W}_{M}} ) ) & ( 8 )\end{matrix}$$

Here, χ^{T} represented by equation (8) is a constant depending on the shape of the multi-mode interference coupler 13 and defined by W_{S}, W_{M}, and the parameter f, which represent the width of the multi-mode interference coupler 13.

Then, from the equations (3) and (7), the relationship between the constant χ^{T} and the beat lengths L_{Tπ} of the multi-mode interference coupler 13 of the optical hybrid circuit 10 shown in FIG. 5 can be obtained as represented by equation (9).

$${L}_{T π} = \frac{{L}_{π}}{{χ}^{T}} \qquad ( 9 )$$

Thus, using the beat length L_{π} of such a rectangular multi-mode interference coupler, the beat length L_{π} of the multi-mode interference coupler 13 of the optical hybrid circuit 10 can be represented.

As represented by equation (9), if the beat length L_{π} of the rectangular multi-mode interference coupler is constant, then the beat length L_{π} of the multi-mode interference coupler 13 is reverse proportion to the constant χ^{T}. Therefore, it is found that the device length L_{M3} of the multi-mode interference coupler 13 shown in FIG. 5 is shortened with an increase in χ^{T}. In other words, in the optical hybrid circuit 10, if the width W_{S} of each of the first part 13a and the third part is equal to the width W_{MMI} of the rectangular multi-mode interference coupler shown in FIG. 2, the device length L_{M3} of the multi-mode interference coupler 13 is shortened from the device length L_{MMI} of the multi-mode interference coupler shown in FIG. 2 at a rate of 1/χ^{T}.

The χ^{T} can be determined by defining the parameter f while defining the widths W_{S} and W_{M} of the multi-mode interference coupler 13. Similarly, as represented by equation (6), the length L_{ST} of the second part 13b is also determined by the parameter f. Therefore, if the widths W_{S} and W_{M} are constant, the determination of χ^{T} leads to define the parameter f. Thus, the length L_{ST} of the second part 13b can be also determined similarly. Here, the beat length L_{Tπ} is used as the device length L_{M3} in equation (6).

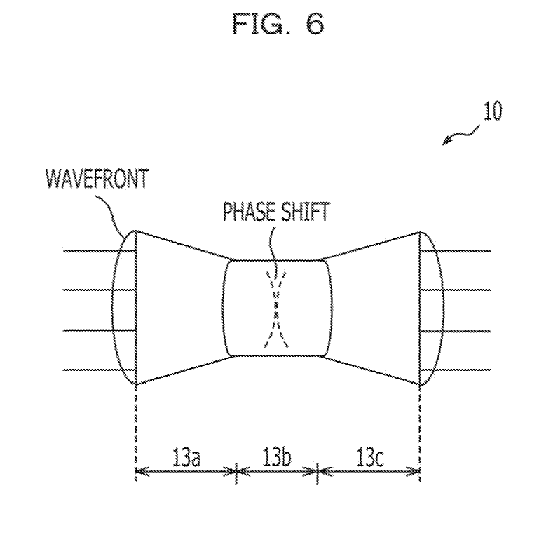

FIG. 6 is a schematic diagram illustrating a wavefront propagating in the multi-mode interference coupler 13 of the optical hybrid circuit 10 shown in FIG. 5.

In the optical hybrid circuit 10, as shown in FIG. 6, the wavefront of a signal beam input from the input channel 11 to the multi-mode interference coupler 13 propagates through the multi-mode interference coupler 13 while curving concentrically. Then, the wavefront propagating the inside of the multi-mode interference coupler 13 causes a phase shift in the middle part of the multi-mode interference coupler 13 due to the discontinuity of the wave number vector of the propagating signal beam. To obtain good optical property of the optical hybrid circuit 10, it is preferable that the phase shift is small.

The optical hybrid circuit 10 compensates the phase shift by adjustment of the length L_{ST} of the second part 13b of the multi-mode interference coupler 13.

Next, an exemplary computation of the optical property of the optical hybrid circuit 10 will be described below with reference to the drawings.

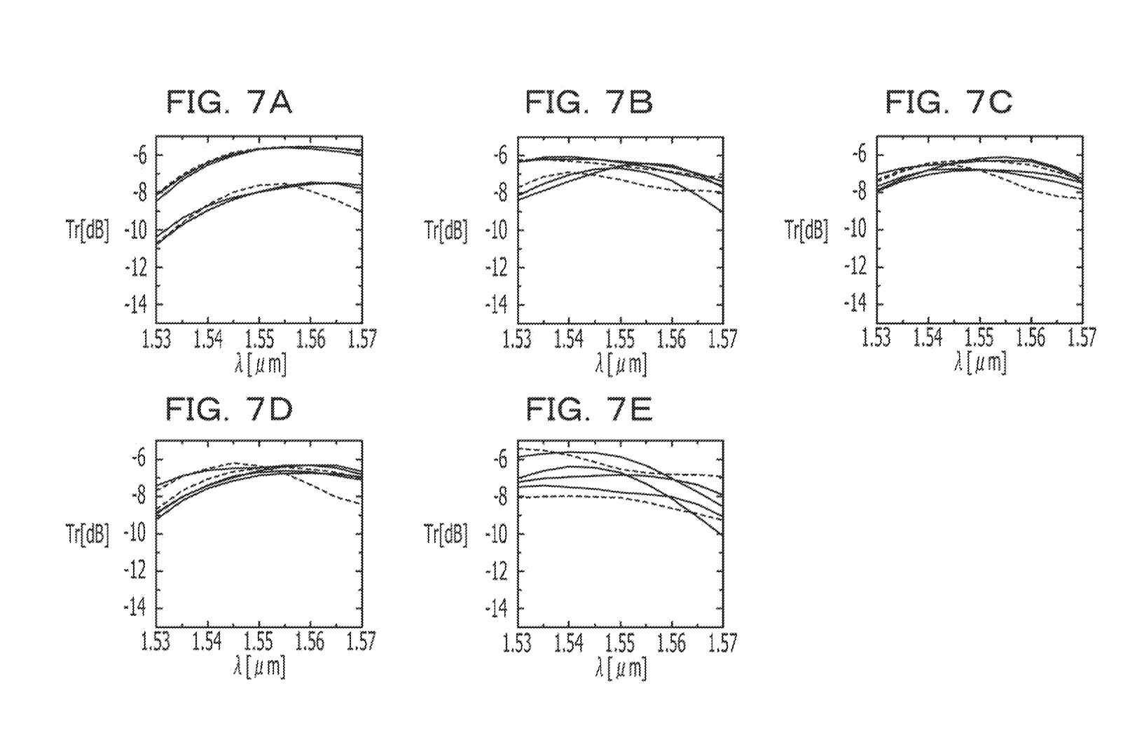

FIGS. 7A to 7E are diagrams illustrating the relationship between the transmittance Tr of each output channel and the wavelength λ of an input signal beam when the length L_{ST} of the second part 13b of the multi-mode interference coupler 13 of the optical hybrid circuit 10 is changed. In each of FIGS. 7A to 7E, a signal beam is input from one of four input channels 11 and the result of computing the transmittance Tr of an output signal beam from each of four output channel with respect to the wavelength λ of the input signal beam is represented by a solid line. In addition, in each of FIGS. 7A to 7E, a signal beam is input from another one of the input channels and the result of computing the transmittance Tr of an output signal beam from each of four output channel with respect to the wavelength λ of the input signal beam is represented by a chain line. In other words, in each of FIGS. 7A to 7E, the transmittance Tr is represented by four solid lines and four chain lines. The transmittance Tr represents the light intensity of each of signal beams output from four output channels 12 by the unit of dB based on the light intensity of the input QPSK signal beam.

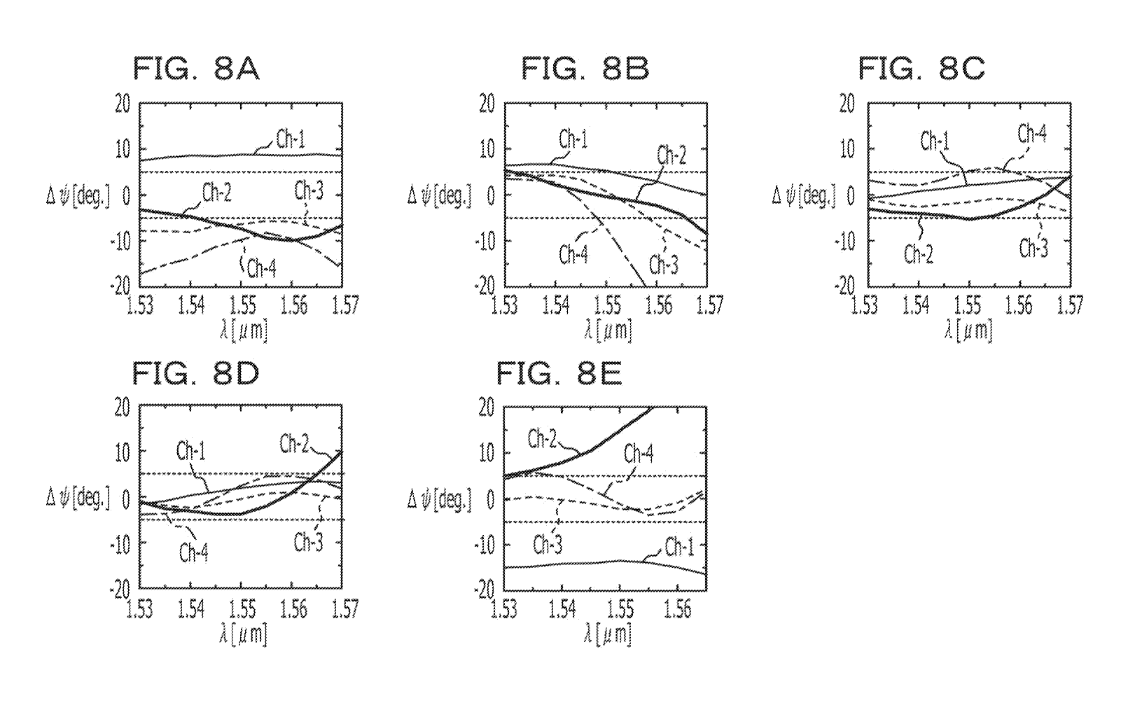

Furthermore, FIGS. 8A to 8E are diagrams illustrating the relationship between the phase shift of each output channel and the wavelength λ of an input signal beam when the length L_{ST} of the second part 13b of the multi-mode interference coupler of the optical hybrid circuit 10 is changed. In each of FIGS. 8A to 8E, a QPSK signal beam and a LO light are input into two input channels 11 and the result of computing the phase difference Δψ calculated from the light intensity of each of signal beams output from four output channels with respect to the wavelength λ of an input signal beam is represented. Specifically, if the output signal beam is an in-phase component, the difference between the phase of the signal beam and 0 or 180 degrees means the phase shift Δψ. In addition, if the output signal beam is an orthogonal component, then the difference between the phase of the signal beam and 90 or 270 degrees means the phase shift Δψ. In each of FIGS. 8A to 8E, an operation band is represented at a phase difference of ±5 degrees.

The results shown in FIGS. 7A to 7E and FIGS. 8A to 8E were calculated using the beam propagation method (BPM). In the calculation by the BPM, the equivalent refractive index of the waveguide region of the multi-mode interference coupler was 3.24 and the refractive index of any region other than the waveguide was 1.0. Furthermore, the size of each component that made up the optical hybrid circuit 10 was as follows: The width of each of input and output channels 11 and 12 was 2.0 μm, the distance between the input channel 11 and the output channel 12 was 2.3 μm, the width W_{S} was 17.2 μm, and the width W_{M} was 13.2 μm.

In the calculation by the BMP, first, 1/χ^{T} was determined as a shortening rate and the beat length L_{Tπ} was then determined. Next, the length L_{ST} and the width W_{M} of the second part 13b were changed to enhance the device length L_{M3} to represent the most preferable transmittance for each length L_{ST} of the second part 13b. Thus, the parameter f, which is an arbitrary real number, is defined and the device length L_{M3} suitable for the defined parameter f is then calculated. Subsequently, for each device, the most preferable device length may be selected with respect to the transmittance and the phase shift property.

Specifically, in FIG. 7A and FIG. 8A, the device length L_{M3} is 477.5 μm and the length L_{ST} is 0 μm. In FIG. 7B and FIG. 8B, the device length L_{M3} is 462.8 μm and the length L_{ST} is 50 μm. In FIG. 7C and FIG. 8C, the device length L_{M3} is 449.0 μm and the length L_{ST} is 100 μm. In FIG. 7D and FIG. 8D, the device length L_{M3} is 446.3 μm and the length L_{ST} is 110 μm. In FIG. 7E and FIG. 8E, the device length L_{M3} is 436.0 μm and the length L_{ST} is 150 μm.

In FIGS. 7A to 7E and FIGS. 8A to 8E, good transmittance and small phase difference can be obtained when the length L_{ST} of the second part 13b is especially in the range of 100 μm to 110 μm. That is, an input signal beam is equally divided to four output channels and then output as signal beams with small phase shift in a wide range of wavelengths. In other words, if the length L_{ST} of the second part 13b is in the range of 100 μm to 110 μm, it is found that the optical hybrid circuit 10 has good optical performance in a C-band region.

Here, in FIG. 7A and FIG. 8A, the length of L_{ST} of the second part 13b is 0 μm. In other words, the transmittance and the phase difference of the optical hybrid circuit shown in FIG. 3 are shown. As shown in FIG. 7A and FIG. 8A, it is found that the optical hybrid circuit shown in FIG. 3 causes a large decrease in optical property when the device length is shortened.

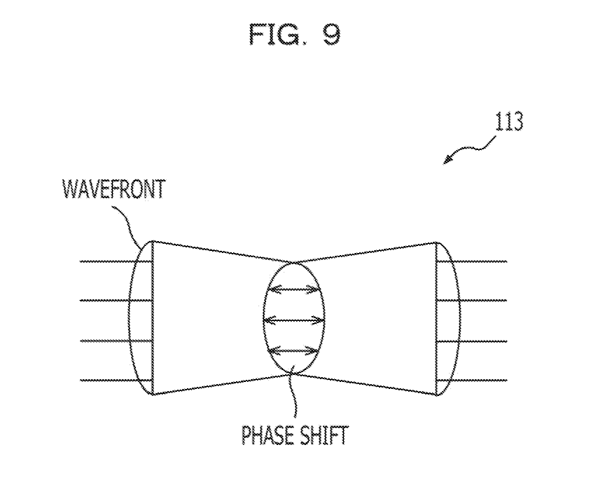

FIG. 9 is a diagram illustrating the wavefront propagating the inside of the optical hybrid circuit shown in FIG. 3.

In the optical hybrid circuit 113 shown in FIG. 3 as schematically illustrated in FIG. 9, the wavefront of a signal beam input from the input channel to the multi-mode interference coupler propagates through the multi-mode interference coupler while curving concentrically. Then, the wavefront propagating the inside of the multi-mode interference coupler causes a phase shift in each of the discontinuous point parts on both side parts of the multi-mode interference coupler. Therefore, the optical hybrid circuit 113 shown in FIG. 3 exerts optical property as shown in FIG. 7A and FIG. 8A.

On the other hand, as has been described with reference to FIG. 6, the optical hybrid circuit 10 compensates the phase shift caused between the first part 13a and the third part 13c by forming the second part 13b of the multi-mode interference coupler 13. Then, the amount of the phase to be compensated can increase by extending the length L_{ST} of the second part 13b. In the examples shown in FIGS. 7A and 7B and FIGS. 8A and 8B, the length L_{ST} of the second part 13b is small. Thus, the amount of the phase to be compensated may be in the insufficient state. Furthermore, the examples shown in FIGS. 7C and 7D and FIGS. 8C and 8D, the amount of the phase to be compensated by the length L_{ST} of the second part 13b may be in the state of corresponding to the phase shift. On the other hand, in the examples shown in FIG. 7E and FIG. 8E, the length L_{ST} of the second part 13b is too long, the phase shift may be in an excessively compensated state.

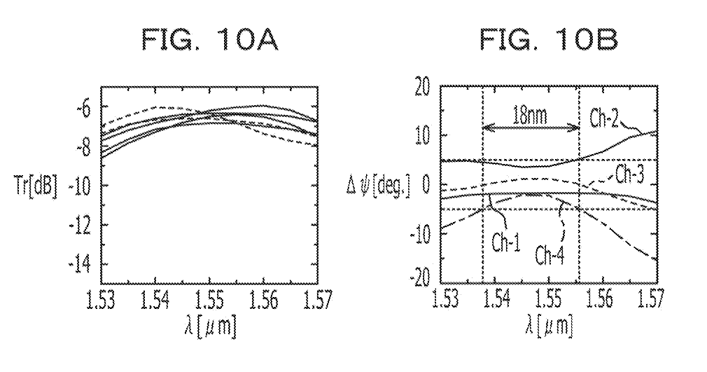

FIG. 10A is a diagram illustrating the relationship between the transmittance of each output channel of the conventional optical hybrid circuit shown in FIG. 4 and the wavelength of an input signal beam. FIG. 10B is a diagram illustrating the relationship between the phase shift of each output channel and the wavelength of an input signal beam. In FIG. 10A and FIG. 10B, the size of each component that made up the optical hybrid circuit was as follows: The width of each of input and output channels 11 and 12 was 2.0 μm, the distance between the input channel 11 and the output channel 12 was 2.3 μm, the width W_{MMI} was 17.2 μm, and the width W_{MP} was 13.2 μm. The shortening rate of the device length was 70%.

As shown in FIG. 10A, the optical hybrid circuit shown in FIG. 4 has good transmittance in a wide range of wavelengths. However, as shown in FIG. 10B, it is found that the range in which the phase shift falls within the range of −5 degrees to +5 degrees can be extensively narrowed.

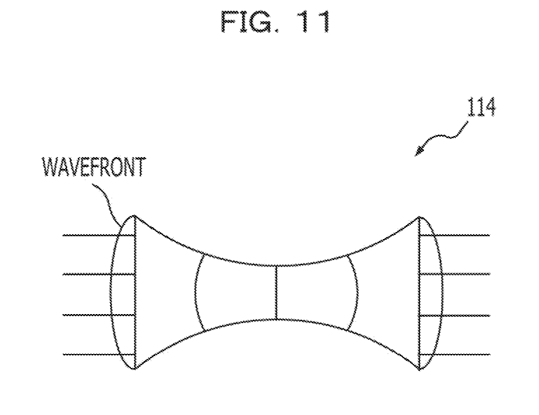

FIG. 11 is a diagram illustrating the waveform that propagates through the optical hybrid circuit shown in FIG. 4.

In the optical hybrid circuit 114 shown in FIG. 4, as schematically illustrated in FIG. 11, the wavefront of a signal beam input from the input channel into the multi-mode interference coupler propagates through the multi-mode interference coupler while curving concentrically. Then, the wavefront propagating the inside of the multi-mode interference coupler is output from an output channel without causing the phase shift. However, the optical hybrid circuit 114 shown in FIG. 4 has poor optical property for the phase shift as shown in FIG. 10B. Thus, for example, good optical performance cannot be obtained at the C band region.

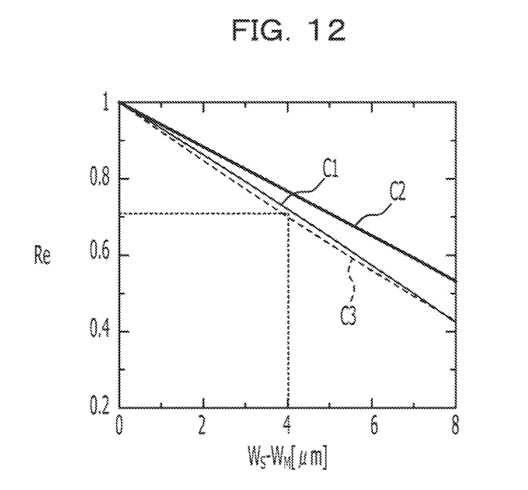

FIG. 12 is a diagram making a comparison between the shortening rate of the optical hybrid circuit of the first embodiment and the shortening rate of the optical hybrid circuit shown in each of FIG. 3 and FIG. 4.

In FIG. 12, the relationship of the difference between the width W_{S} and the width W_{M} to the shortening rate Re of the device length is represented by curve C1 for the optical hybrid circuit 10 shown in FIG. 5. The curve C1 was calculated by the BPM with the same conditions as those of FIG. 7C and FIG. 8C. Here, the shortening rate Re is 1/χ^{T}.

As shown in FIG. 12, the curve C1 decreases almost linearly. As represented by the equation (8), a variation in curve C1 can be recognized from the fact that a decrease in 1/χ^{T} occurs as an increase in difference between the width W_{S} and the width W_{M} occurs.

In FIG. 12, furthermore, the relationship of the difference between the width W_{S} and the width W_{M} to the shortening rate Re of the device length is represented by curves C2 and C3 for the optical hybrid circuits shown in FIGS. 3 and 4, respectively. In the optical hybrid circuits shown in FIG. 3 and FIG. 4, the shortening rate can be similarly derived using the equation (9).

From the comparison between the curve C1 and the curve C2 in FIG. 12, it is found that the optical hybrid circuit 10 shown in FIG. 5 has an excellent shortening rate for the values on the horizontal axis, compared with that of the optical hybrid circuit shown in FIG. 3.

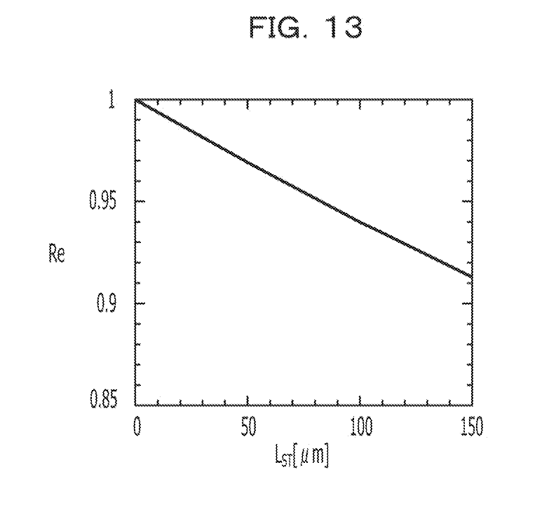

Furthermore, FIG. 13 illustrates the result of comparing the relationship between the shortening rate of the device length and the length L_{ST} with the optical hybrid circuit shown in FIG. 3 as a standard.

FIG. 13 is a diagram illustrating the relationship between the shortening rate Re of the device length of the optical hybrid circuit according to the first embodiment and the length L_{ST} of the second part.

In FIG. 13, if the length L_{ST} is zero (0), then it corresponds to the optical hybrid circuit shown in FIG. 3. As shown in FIG. 13, the more the length L_{ST} increases, the more the shortening rate Re of the device length linearly decreases. In other words, the more the length L_{ST} increases, the device length of the optical hybrid circuit 10 shown in FIG. 5 can be decreased more than the device length of the optical hybrid circuit shown in FIG. 3.

Furthermore, as shown in FIG. 12, the optical hybrid circuit shown in FIG. 4 has the shortening rate of the device which is equivalent to that of the optical hybrid circuit 10 shown in FIG. 5. However, as shown in FIG. 10B, the optical hybrid circuit shown in FIG. 4 has poor optical property for the phase shift when the device length is shortened.

Furthermore, as shown in FIG. 12, the optical hybrid circuit 10 shown in FIG. 5 has a shortening rate Re of about 0.70 under the condition of W_{S}−W_{M}=4 μm when the length L_{ST} of the second part 13b is 100 to 110 μm. As a result, the device length can be reduced about 30% in comparison with the rectangular multi-mode interference coupler. Furthermore, as shown in FIG. 12, a further increase in difference between the width W_{S} and the width W_{M} can lead to a further decrease in shortening rate.

However, in general, there is a trade-off relationship between the shortening rate Re of the device length of the multi-mode interference coupler and the optical property, such as operating bandwidth, of the optical hybrid circuit 10. Next, an exemplary case where the shortening rate of the optical hybrid circuit 10 is further decreased will be described with reference to the drawings.

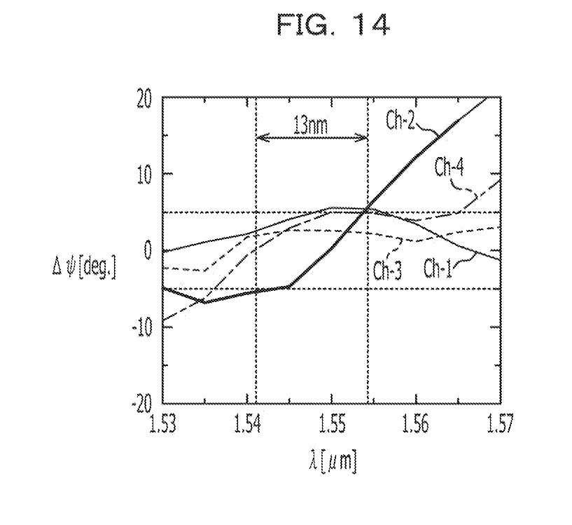

FIG. 14 is a diagram illustrating the relationship between the phase shift of each output channel and the wavelength of an input signal beam when the shortening rate Re of the optical hybrid circuit 10 is set to 0.58. The optical property shown in FIG. 14 was calculated for the case where L_{ST}=80 μm and W_{S}−W_{M}=6 μm.

As shown in FIG. 14, the operating bandwidth of the optical hybrid circuit 10 is decreased more than the operating bandwidths shown in FIG. 8C and FIG. 8D.

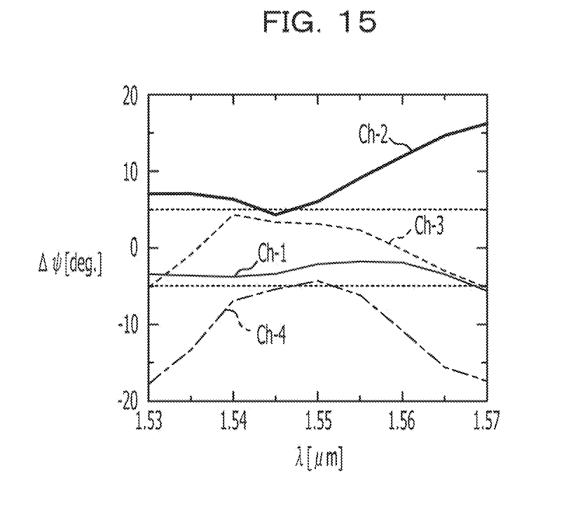

FIG. 15 is a diagram illustrating the relationship between the phase shift of each output channel and the wavelength of an input signal beam when the shortening rate of the optical hybrid circuit shown in FIG. 4 is set to 0.58.

As shown in FIG. 15, the phase shift of the optical hybrid circuit shown in FIG. 4 when the shortening rate is set to 0.58 is still larger than that of the optical hybrid circuit 10 shown in FIG. 5. Thus, the optical hybrid circuit 10 of the present embodiment causes a decrease in operating bandwidth when the shortening rate is further reduced from 0.70, while having the operating bandwidth which is wider than that of the optical hybrid circuit shown in FIG. 4.

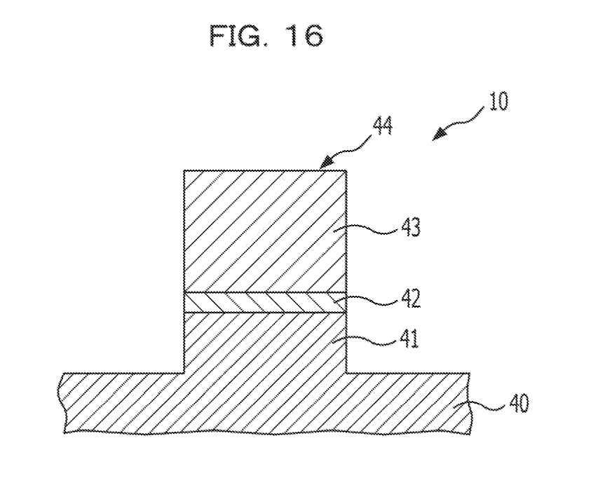

FIG. 16 is a cross-sectional diagram along the line X-X of FIG. 5.

The optical hybrid circuit 10 is formed such that a lower cladding layer 41 is disposed on a substrate 40, a core layer 42 is disposed on the lower cladding layer 41, and an upper cladding layer 43 is disposed on the core layer 42. A mesa part 44 is constructed of the lower cladding layer 41, the core layer 42, and the cladding layer 43. Here, the lower cladding layer 41 and the substrate 40 are integrally formed in the optical hybrid circuit 10.

The cross-sectional view shown in FIG. 16 is that of the second part 13b of the multi-mode interference coupler 13. It is noted that each of the first part 13a, the third part 13c, the input channels 11, and the output channels 12 have a similar cross-sectional structure. In other words, the thickness of each of the lower cladding layer 41, the core layer 42, and the upper cladding layer 43 is constant over the entire optical hybrid circuit 10.

For example, the optical hybrid circuit 10 shown in FIG. 5 may be formed as follows.

For example, the core layer 41 is disposed on the substrate 40 by a metal-organic vapor phase epitaxy method (hereinafter, also referred to as a MOVPE method). The substrate 40 may be an n-type InP substrate or an undoped InP substrate. As a forming material of the core layer 42, undoped GaInAsP (an emission wavelength of 1.30 μm) can be used. For example, the core layer 42 may have a thickness of 0.3 μm.

The upper cladding layer 43 is epitaxially deposited on the core layer 42. As a forming material of the upper cladding layer 43, undoped or p-type InP can be used. For example, the upper cladding layer 43 may have a thickness of 2.0 μm.

A mask layer, such as a SiO2 film, is formed on the upper cladding layer 43.

An optical exposure process is used for patterning an area for forming an optical hybrid circuit in the mask layer.

The mask layer is used as a mask to etch the upper cladding layer 43, the core layer 42, and the substrate 40, thereby forming the mesa part 44. As shown in FIG. 16, the substrate 40 is etched from the surface of the substrate 40 partway through the substrate 40 to form a convexed lower cladding layer 41. As an etching method, for example, dry etching, such as inductively coupled plasma (ICP) reactive ion etching may be used. In addition, for example, the mesa part 44 may have a height of 3.0 μm.

The optical hybrid circuit 10 is formed by removing the mask layer from the upper cladding layer 43.

Here, the above exemplified method for forming the optical hybrid circuit 10 has been described as one using InP, which is a III-V group compound semiconductor, as a forming material. However, the forming material is not limited to any of these material systems. Alternatively, for example, the optical hybrid circuit may be formed using GaAs (III-V group compound semiconductor), Si (IV group semiconductor), or the like.

The optical hybrid circuit 10 of the aforementioned present embodiment has small dimensions and is excellent in optical performance.

In addition, the optical hybrid circuit 10 of the present embodiment is suitable for monolithic integration. As described above, the device length of the multi-mode interference coupler 13 of the optical hybrid circuit 10 can be shortened at least about 30% while keeping good optical property.

Furthermore, in the optical hybrid circuit 10, the device length of the multi-mode interference coupler can be shortened without reducing the distance between the input channels and the distance between the output channels. Therefore, the optical hybrid circuit 10 can be formed using a manufacturing process with conventional processing accuracy.

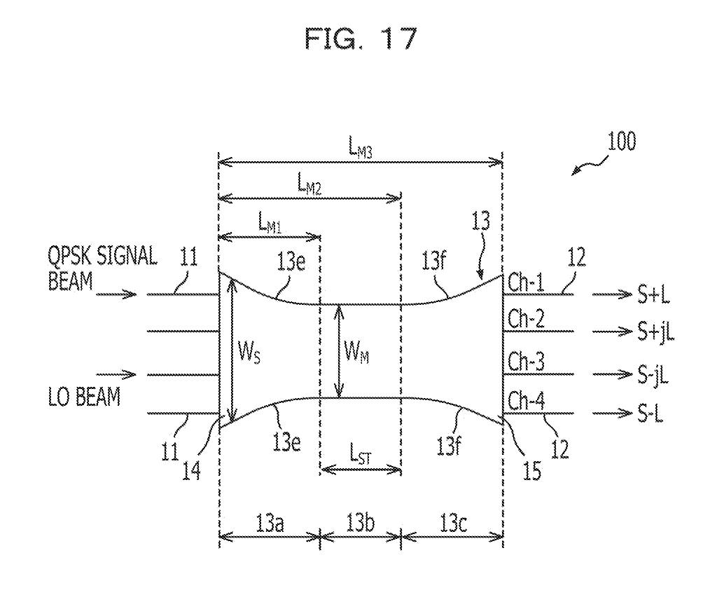

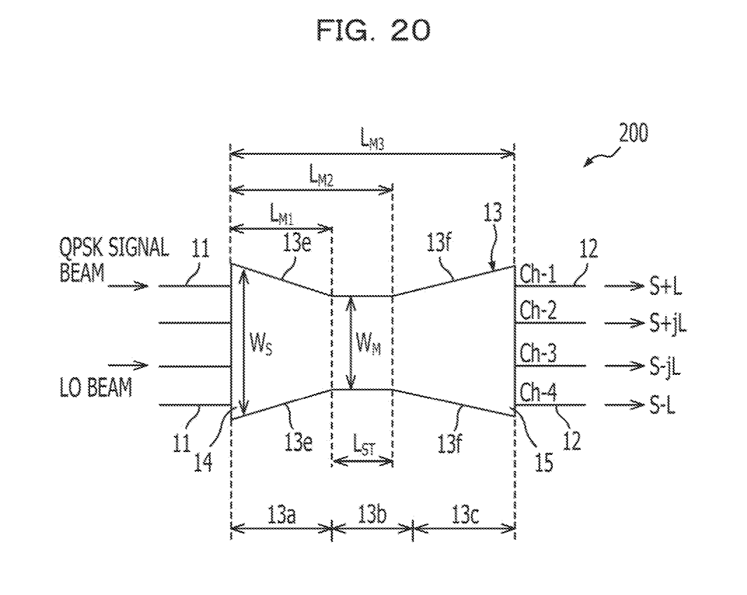

Next, an optical hybrid circuit as an example of the optical waveguide device according to each of second and third embodiments disclosed in the present specification will be described with reference to the attached drawing. To any point which is not specifically described for the second and third embodiments, the detailed description about the aforementioned first embodiment will be suitably applied. In FIG. 17 and FIG. 20, the structural elements that are substantially the same as those in FIG. 5 are designated by the same reference numerals.

FIG. 17 is a diagram illustrating an optical hybrid circuit according to the second embodiment disclosed in the present specification.

The optical hybrid circuit 100 of the present embodiment includes a pair of side parts 13e that define the width of the first part 13a of the multi-mode interference coupler 13. Each of the side parts 13e is in a parabolic shape inwardly. Similarly, the optical hybrid circuit 100 includes a pair of side parts 13f that define the width of the third part 13c of the multi-mode interference coupler 13. Each of the side parts 13f is also in a parabolic shape inwardly.

Other parts of the optical hybrid circuit 100 are substantially the same as those of the first embodiment described above.

Then, the optical property of the optical hybrid circuit 100 of the present embodiment will be compared with the aforementioned first embodiment with reference to the drawings.

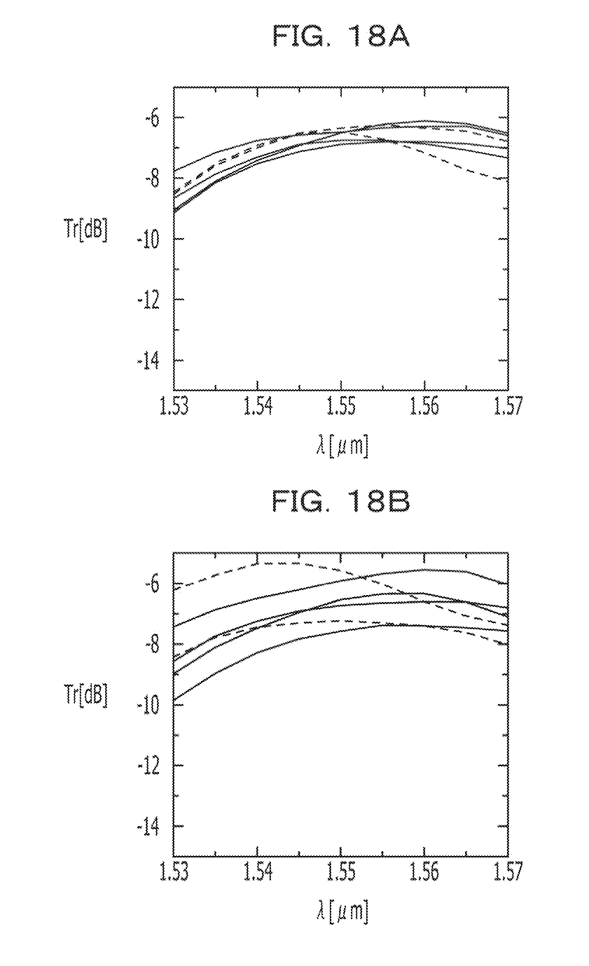

FIG. 18A is a diagram illustrating the relationship between the transmittance of each output channel of the optical hybrid circuit of the first embodiment and the wavelength of an input signal beam. FIG. 18B is a diagram illustrating the relationship between the transmittance of each output channel of the optical hybrid circuit 100 of the second embodiment and the wavelength of an input signal beam.

In FIG. 18A, calculation was performed under substantially the same conditions as those of FIG. 7C. In FIG. 18B, calculation was performed under substantially the same conditions as those of FIG. 18A except that the first part 13a and the third part 13c are different in shape.

The transmittance of the optical hybrid circuit of the first embodiment is superior to the transmittance of the optical hybrid circuit 100 of the present embodiment. In other words, the optical hybrid circuit of the first embodiment is superior in that an input signal beam can be substantially equally divided into the respective output channels.

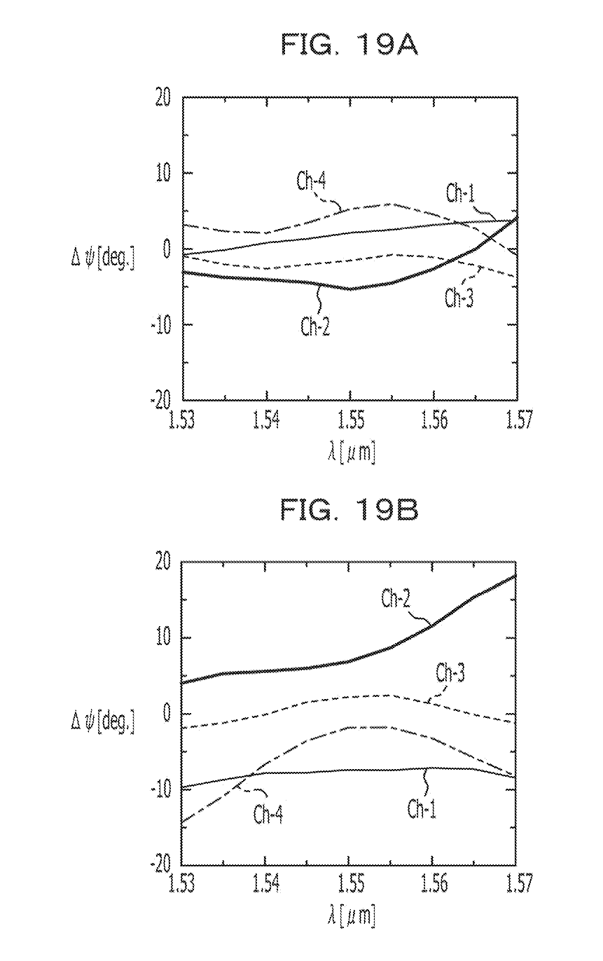

FIG. 19A is a diagram illustrating the relationship between the phase shift of each output channel of the optical hybrid circuit of the first embodiment and the wavelength of an input signal beam. FIG. 19B is a diagram illustrating the relationship between the phase shift of each output channel of the optical hybrid circuit 100 of the second embodiment and the wavelength of an input signal beam.

In FIG. 19A, calculation was performed under substantially the same conditions as those of FIG. 8C. In FIG. 19B, calculation was performed under substantially the same conditions as those of FIG. 19A except that the first part 13a and the third part 13c are different in shape.

The phase shift of each output signal beam in the first embodiment is smaller than that of the optical hybrid circuit 100 of the present embodiment. In other words, the optical hybrid circuit of the first embodiment is superior in that the phase of the input signal beam can be kept with good accuracy.

FIG. 20 is a diagram illustrating an optical hybrid circuit according to the third embodiment disclosed in the present specification.

In the optical hybrid circuit 200 of the present embodiment, the length L_{M1} of the first part 13a of the multi-mode interference coupler 13 in the propagation direction is shorter than the length (L_{M3}−L_{M2}) of the third part 13c thereof. In other words, the optical hybrid circuit 200 is designed to form the first part 13a and the third part 13c are symmetrical with respect to the center axis (not shown) in the optical propagation direction of the optical hybrid circuit 200.

The intervals of the respective output channels 12 coupled to the other end part 15 in the width direction are substantially equal to those of the respective input channels 11 coupled to one end part 14 in the width direction.

Other parts of the optical hybrid circuit 100 are substantially the same as those of the first embodiment described above.

The optical property of the optical hybrid circuit 200 of the present embodiment will be compared with the aforementioned first embodiment with reference to the drawings.

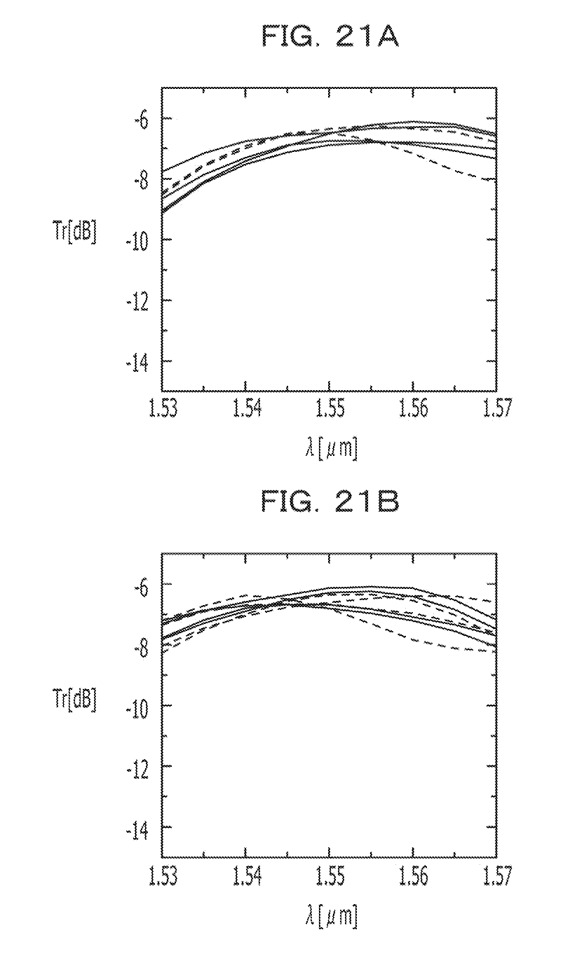

FIG. 21A is a diagram illustrating the relationship between the transmittance of each output channel of the optical hybrid circuit of the first embodiment and the wavelength of an input signal beam. FIG. 21B is a diagram illustrating the relationship between the transmittance of each output channel of the optical hybrid circuit 200 of the third embodiment and the wavelength of an input signal beam.

In FIG. 21A, calculation was performed under substantially the same conditions as those of FIG. 7C. In FIG. 21B, calculation was performed under substantially the same conditions as those of FIG. 21A except that the first part 13a and the third part 13c are different in length in the direction of optical propagation.

The transmittance of the optical hybrid circuit of the first embodiment is slightly superior to the transmittance of the optical hybrid circuit 200 of the present embodiment. In other words, the optical hybrid circuit of the first embodiment is superior in that an input signal beam can be substantially equally divided into the respective output channels.

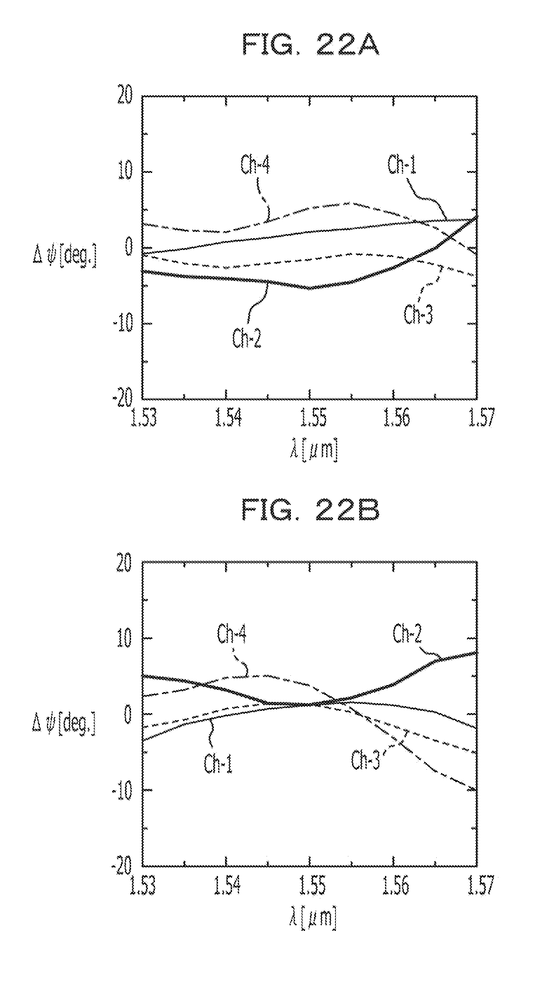

FIG. 22A is a diagram illustrating the relationship between the phase shift of each output channel of the optical hybrid circuit of the first embodiment and the wavelength of an input signal beam. FIG. 22B is a diagram illustrating the relationship between the phase shift of each output channel of the optical hybrid circuit 200 of the third embodiment and the wavelength of an input signal beam.

In FIG. 22A, calculation was performed under substantially the same conditions as those of FIG. 8C. In FIG. 22B, calculation was performed under substantially the same conditions as those of FIG. 22A except that the first part 13a and the third part 13c are different in length in the direction of optical propagation.

The phase shift of each output signal beam in the first embodiment is smaller than that of the optical hybrid circuit 200 of the present embodiment. In other words, the optical hybrid circuit of the first embodiment is superior in that the phase of the input signal beam can be kept with good accuracy.

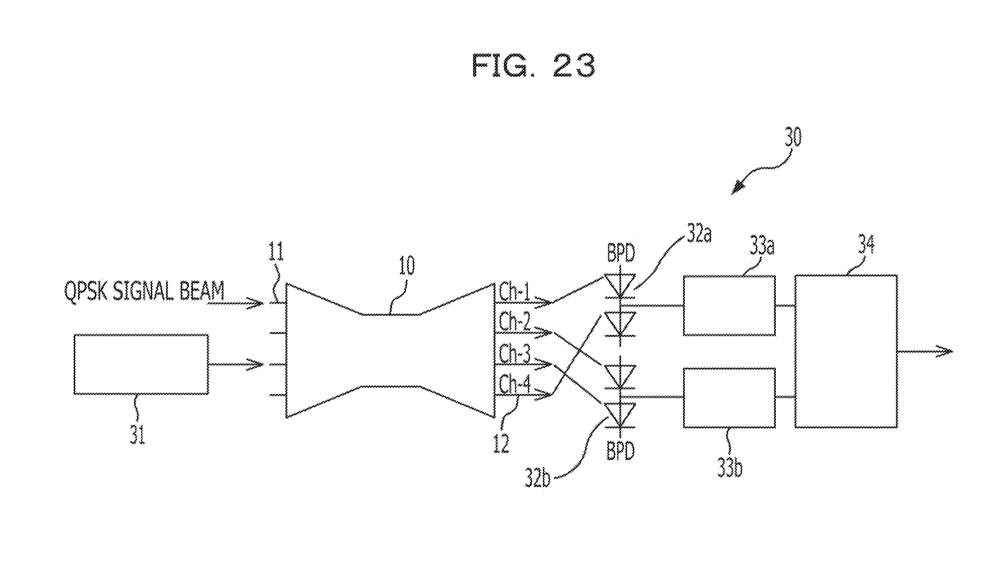

Next, an optical receiver equipped with the above optical hybrid circuit disclosed in the present specification will be described below with reference to the drawings. FIG. 23 is a diagram illustrating a coherent optical receiver according to one embodiment disclosed in the present specification.

A coherent optical receiver 30 includes the above optical hybrid circuit 10 of the first embodiment.

In addition, the coherent optical receiver 30 includes a LO optical source 31 as a local oscillation beam generator that generates a LO beam and outputs the LO beam to the optical hybrid circuit 10 and photoelectric converters 32a and 32b that convert each output optical signal from the optical hybrid circuit 10 into an electric signal. Specifically, balanced photodiodes (BPDs) may be used as the photoelectric converters 32a and 32b. An output signal of an in-phase component is input to each of two photodiodes of the BPD 32a and an output signal of an orthogonal component may be input to two photodiodes of the BPD 32b.

In addition, the coherent optical receiver 30 includes: AD converters 33a and 33b that receive the respective analog electrical signals output from the photoelectric converters 32a and 32b; and a digital arithmetic circuit 34 as a phase estimation unit for estimating a phase by inputting a digital electrical signal.

The use of a monolithic integrated circuit as an optical hybrid circuit 10 is preferable to miniaturize the coherent optical receiver 30.

Next, the operation of the coherent optical receiver 30 will be described.

First, a QPSK signal beam and the LO beam synchronized with this QPSK signal beam are input into the input channels 11 of the optical hybrid circuit 10, respectively.

In the optical hybrid circuit 10, depending on the relative phase difference Δφ between the LO beam and the QPSK signal beam, these signal beams are self-imaged by multi-mode interference then output from four output channels 12, respectively.

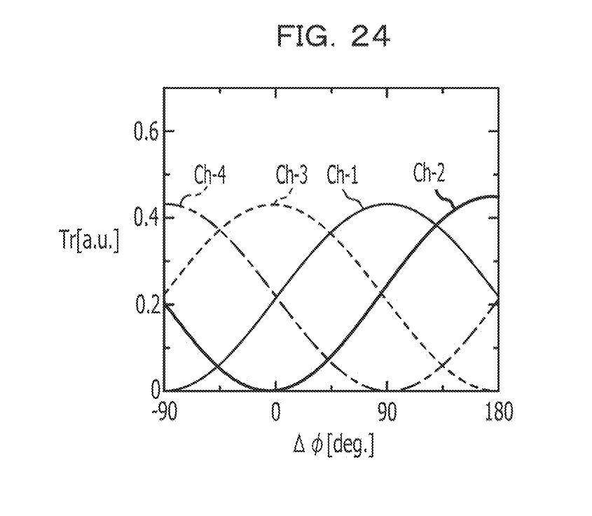

FIG. 24 is a diagram illustrating the transmittance of each output channel when the QPSK signal beam is input into the optical receiver shown in FIG. 23.

FIG. 24 represents the transmittance of each of output channels when (a) Δφ=0, (b) Δφ=π, (c) Δφ=−π/2, and (d) Δφ=π/2. The transmittance ratios of the respective four output beams at the relative phase difference Δφ are (a) 1:0:2:1, (b) 1:2:0:1, (c) 0:1:1:2, and (d) 2:1:1:0, respectively.

Then, the signal beams from the respective output channels are input into BPDs 32a and 32b.

The BPDs 32a and 32b output electric current which is equivalent to +1 for the input to the upper photodiode and electric current which is equivalent to −1 for the lower photodiode. In contrast, substantially simultaneous inputs to the upper and lower photodiodes do not cause any output of current. Thus, the BPDs 32a and 32b convert output signal beams into electrical signals and then output them to AD converters 33a and 33b, respectively.

The AD converters 33a and 33b, which has received the inputs of analog electrical signals output from the BPDs 32a and 32b, convert the analog electrical signals into digital electrical signals and then outputs them to the digital arithmetic circuit 34.

The digital arithmetic circuit 34 receives the input of digital electrical signals and then estimates a phase, followed by outputting the estimated phase. In this way, the coherent receiver 30 demodulates the input QPSK signal beam.

The coherent receiver 30 of the aforementioned present embodiment has small dimensions and is excellent in optical performance.

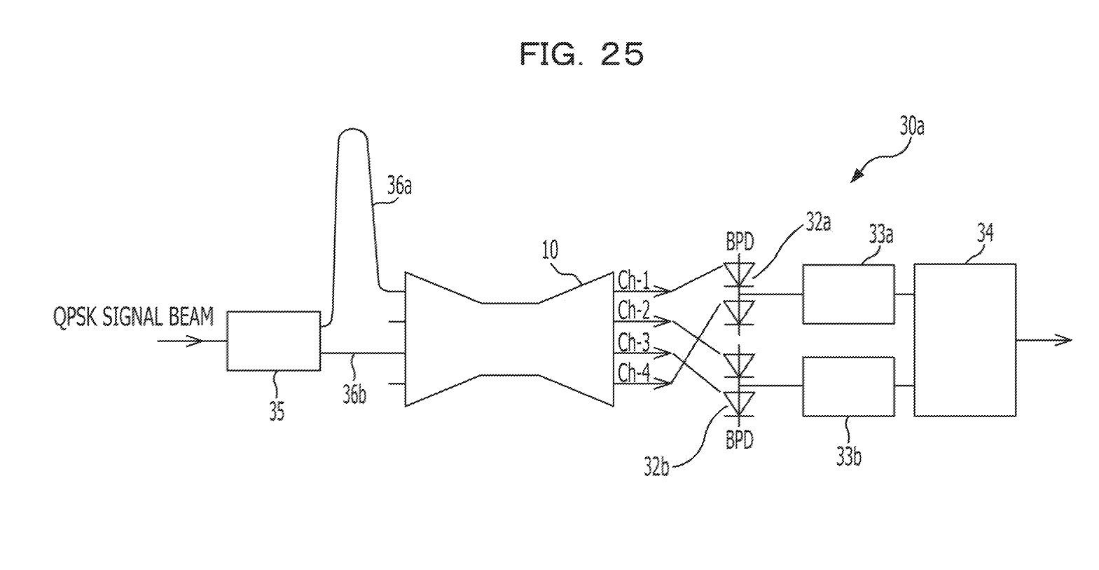

FIG. 25 is a diagram illustrating another embodiment of the optical receiver disclosed in the present specification.

The optical receiver 30a of the present embodiment receives a DQPSK signal beam as an input.

The coherent optical receiver 30a includes a 1:2 MMI coupler 35 that receives a DQPSK signal beam as an input and then divides the input into two output signal beams to be output. These two signal beams output from the 1:2 MMI coupler 35 propagate through two waveguides 36a and 36b, followed by entering into the optical hybrid circuit 10. Here, the optical path length of the waveguide 36a is longer than that of the waveguide 36b by one bit of the DQPSK signal beam.

Two DQPSK signal beams input into the optical hybrid circuit 10 are different in phase by one bit from each other. Thus, these signal beams are self-imaged by multi-mode interference in the optical hybrid circuit 10 and then output from the respective four output channels 12. Other operations of the coherent optical receiver 30a are substantially the same as those of the above embodiments.

In the present invention, the optical hybrid circuit and the optical receiver equipped with such an optical hybrid circuit of the respective embodiment described above can be suitably changed unless they deviate from the present invention. In addition, the requirements in one of the above embodiments or modifications thereof are mutually replaceable with those of others. For example, when direct detection is considered, the number of output channels is set to two when receiving a BPSK signal beam as an input. Alternatively, the number of output channels is set to eight when receiving an 8PSK signal beams as inputs.

All the examples and conditional terms described herein intend to instructive purposes for helping for readers to deeply acquire the skill while understanding the invention and the concepts thereof contributed by the inventors. All the examples and conditional language described herein should be interpreted without being limited to those concretely described herein. While the embodiments of the present invention have been described in detail, it should be understood that various changes, substitutions, or modifications of the invention may be made without departing from the spirit and scope of the invention.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. An optical waveguide device, comprising:
a plurality of input channels;
a plurality of output channels; and
a multi-mode interference coupler having one end part coupled to the plurality of input channels and an other end part coupled to the plurality of output channels,
the multi-mode interference coupler includes
a first part gradually narrowing in width from the one end part to the other end part,
a second part coupling to the first part and extending from the one end part to the other end part while keeping the width of a coupling part between the first part and the second part, and
a third part coupling to the second part and gradually thickening in width from the one end part to the other end part.

2. The optical waveguide device according to claim 1, wherein
the width of the first part is defined by a pair of side parts which are opposite to each other and each of the side parts is linearly shaped.

3. The optical waveguide device according to claim 1, wherein
the width of the third part is defined by a pair of side parts which are opposite to each other and each of the side parts is linearly shaped.

4. The optical waveguide device according to claim 1, wherein
the first part and the third part have substantially a same length in the direction extending from the one end part to the other end part.

5. The optical waveguide device according to claim 1, wherein
a multilevel phase-shift keying signal beam is input into one of the plurality of input channels, and
the length of the second part in the direction extending from the one end part to the other end part is defined so that a difference between the light intensities of the respective signal beams output from the plurality of output channels is set to 6 dB or less based on the light intensity of the multilevel phase-shift keying signal beam.

6. The optical waveguide device according to claim 1, wherein
the number of the input channels is two and the number of the output channels is four.

7. The optical waveguide device according to claim 1, wherein
the optical waveguide device is a monolithic integrated circuit.

8. An optical receiver comprising an optical waveguide device,
the optical waveguide device includes:
a plurality of input channels;
a plurality of output channels; and
a multi-mode interference coupler having one end part coupled to the plurality of input channels and an other end part coupled to the plurality of output channels,
the multi-mode interference coupler includes
a first part gradually narrowing in width from the one end part to the other end part,
a second part coupling to the first part and extending from the one end part to the other end part while keeping the width of a coupling part between the first part and the second part, and
a third part coupling to the second part and gradually thickening in width from the one end part to the other end part.

9. The optical receiver according to claim 8, wherein
the optical waveguide device is a monolithic integrated circuit.

10. The optical receiver according to claim 9, further comprising:
a photoelectric converter for changing each output optical signal from the optical waveguide device into an electrical signal; an
a phase estimation unit that receives each electric signal output from the photoelectric converter as an input and estimates a phase.

11. A multi-mode interference coupler where light propagates from one end part to an other end part, the coupler comprising:
a first part gradually narrowing in width from the one end part to the other end part;
a second part coupling to the first part and extending from the one end part to the other end part while keeping the width of a coupling part between the first part and the second part; and
a third part coupling to the second part and gradually thickening in width from the one end part to the other end part.
